(19) United States
(12) Patent Application Publication
(10) Pub. No.: US 2004/0004990 A1
(43) Pub. Date: Jan. 8, 2004

(54) Temperature sensing in controlled environment

(76) Inventor: Abid L. Khan, Saratoga, CA (US)

Correspondence Address: FENWICK & WEST LLP, SILICON VALLEY CENTER, 801 CALIFORNIA STREET, MOUNTAIN VIEW, CA, 94041, US

(21) Appl. No.: 10/603,376

(22) Filed: Jun. 24, 2003

Related U.S. Application Data
(63) Continuation of application No. 10/170,920, filed on Jun. 12, 2002.
(60) Provisional application No. 60/315,878, filed on Aug. 29, 2001.

(51) Int. Cl. G01K 11/00; G01K 1/16

(52) U.S. Cl. 374/161; 374/120

(57) ABSTRACT

Temperature-sensing apparatus is mounted within a wafer chuck to contact the underside surface of a wafer secured thereby. Photoluminescent material on a sensing element that is mounted in resilient contact with a wafer emits luminous flux in response to radiant-energy stimulation with a characteristic intensity that varies with time as a function of temperature. An optical channel couples radiant energy between the photoluminescent material and a remote optical analyzer that supplies pulses of radiant energy and receives the luminous flux to determine the temperature of the sensing element in contact with the wafer.

### RELATED APPLICATION

This application is a continuation of application Ser. No. 10/170,920 entitled “Temperature Sensing in Controlled Environment”, filed on Jun. 12, 2002 by Abid L. Khan, which claims priority from provisional application Serial No. 60/315,878, entitled “Wafer Temperature Measurement and Control in Real Time Under Processing Conditions,” filed on Aug. 29, 2001, by Abid Khan.

### FIELD OF THE INVENTION

This invention relates to remote temperature sensing in a controlled environment and more particularly to measuring the temperature of a semiconductor wafer within a process chamber.

### BACKGROUND OF THE INVENTION

Contemporary processing equipment for fabricating semiconductor devices commonly include reaction chambers for controlling chemical or electrochemical processing of a semiconductor substrate, or wafer. During such controlled processing, the wafer may be subjected to corrosive chemicals or gas plasmas at elevated temperatures that must be carefully monitored. In addition, the wafer is commonly held in fixed position within the reaction chamber, typically by a vacuum chuck or electrostatic chuck that maintains the rigid fixation from the underside of the wafer. Thus, sensing of the wafer temperature during processing within such a reaction chamber has limited remote-sensing techniques, for example, to optical pyrometry or contact thermometry based upon sensing temperature of the wafer at selected few locations about the wafer. Of course, it is desirable to have temperature sensing not adversely affect the temperature of the object being measured, so techniques involving negligible thermal mass are preferred. Thus, optical measurements and miniature thermocouples are favored for wafer temperature measurements. However, the presence of high-frequency electrical signals associated with gas plasmas commonly inhibit measurement of low-levels signals attributable to thermocouples used in contact thermometry, and ionized plasma gases and various surface coatings deposited on the wafer with various emission coefficients adversely affect the accuracy of optical pyrometry techniques.

### SUMMARY OF THE INVENTION

In accordance with one embodiment of the present invention, optical techniques and thermal contact techniques combine to accurately sense the temperature of the underside of a wafer. Specifically, one or more temperature sensors are disposed at locations within the area of a wafer chuck to make direct thermally-conductive contact with the underside of the wafer, and to provide optical signal indications of temperature for remotely sensing and monitoring the wafer to provide accurate indication of its processing temperature. In this configuration, the temperature-sensing technique of the present invention is unaffected by high-energy radio frequency signals associated with gas-plasma processing of the wafer, or by ambient conditions of reduced pressure and corrosive atmosphere.

### BRIEF DESCRIPTION OF THE DRAWINGS

FIG. 1 is a partial sectional view of a thermal sensor in accordance with one embodiment of the present invention;

FIG. 2 is a sectional view of a mounting spring in the embodiment of FIG. 1; and

FIG. 3 is a graph illustrating the non-linear force versus displacement characteristics of the mounting spring of FIG. 2.

### DETAILED DESCRIPTION OF THE INVENTION

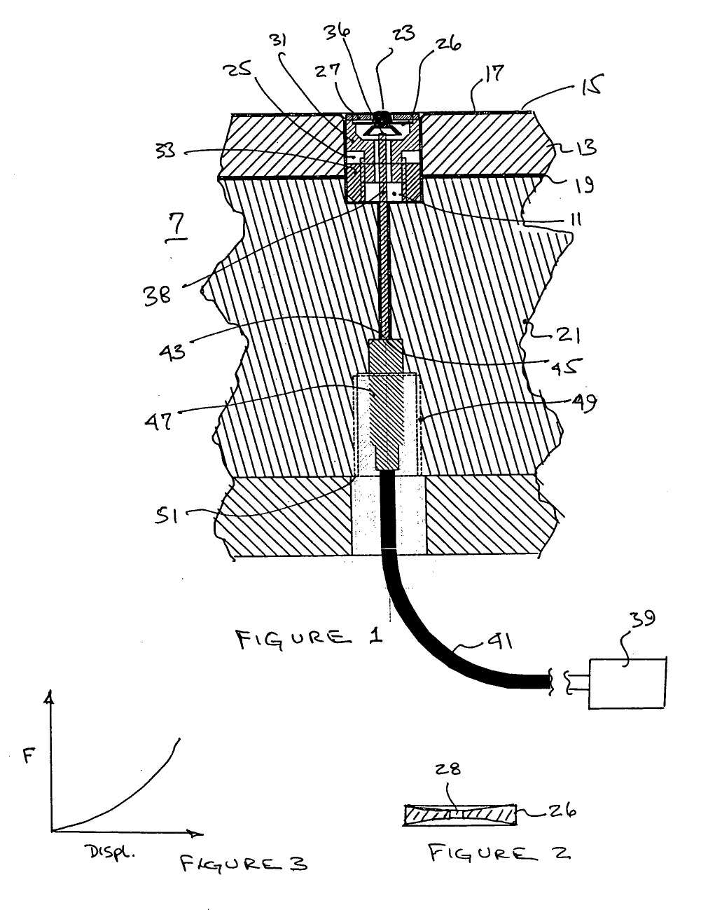

Referring now to FIG. 1, there is shown a partial sectional view of a wafer chuck 7, with a temperature-sensing structure 11 according to one embodiment of the present invention built into the chuck to contact the underside of a wafer supported on the chuck 7. Specifically, an electrostatic wafer chuck 7 may include an electrode 13 having a generally round planar surface 15 that is disposed to support a wafer of slightly greater diameter, and that includes a layer 17 of dielectric material such as aluminum oxide, or the like, interposed between the electrode 13 and a wafer (not shown) positioned on the upper surface of the dielectric layer 17. One or more lower layers 19 of insulating material are interposed between the electrode 13 and a base 21. The electrode 13 and a similar electrode structure at a spaced location about the base 21, insulated from electrode 13 and having an upper surface coplanar with the surface 15 of electrode 13 thus form an electrostatic chuck in known manner. Bipolar electrical signals applied to such electrodes thus establish an electrostatic field therebetween upon application of suitable voltage and polarities that exerts a substantial force on a wafer in a direction toward the surface 15 in known manner to retain the wafer firmly secured to the planar upper surface of the chuck.

In accordance with the illustrated embodiment of the present invention, a tiny, thermally-conductive sensing element 23 is mounted within a recess 25 within the surface 15 of electrode 13 to protrude slightly above the planar surface 15 for assured thermally-conductive contact with the underside surface of a wafer positioned on the surface 15. Resilient mounting of the sensing element 23 is provided by a circular or disc-like spring 26, as illustrated in sectional view in FIG. 2, which surrounds the sensing element 23. Preferably, the spring 26 provides progressively greater spring force with deflection or displacement, as illustrated in FIG. 3, to increase resilient bias of the sensing element 23 against the underside of a wafer as such wafer is drawn into engagement with the surface 15 of the wafer chuck. The spring may be formed of metallic or polymer material with cross-section that increases with radius from the central aperture 28, as shown in FIG. 2, in which the thermal element 23 is supported. The sensing element 23 is formed of highly thermally-conductive material such as aluminum or titanium or ceramic material, and may be similarly coated with dielectric material on the exposed surface, as in layer 15 or 19. Additionally, an annulus 27 is disposed within the recess above the disc spring 26 to surround (but not touch) the sensing element 23 and thereby serve as a shield or barrier to the migration into the structure of gases or chemicals that are present within the operating environment. The disc spring 26 that supports the sensing element 23 is, in turn, coaxially supported about its periphery by a cup-shaped element 31 that is coaxially positioned within the recess 25. The axial position within the recess 25 of the cup-shaped element 31 and of the associated disc spring 26 and sensing element 23 is determined by rotational adjustment of the element 31 within the threaded attachment to the base collar 33. The element 31 and base collar 33 and disc spring 26 and shield 27 may all be formed of low thermally-conductive materials such as polymers or ceramics to inhibit heat transfer from the wafer via contacting sensing element 23.

In accordance with the present invention, the temperature of the sensing element 23 is determined by an actinically-sensitive a photoluminescent material which fluoresces with a decaying intensity as a function of temperature following pulsed light stimulation of the material. The underside of the sensing element 23 is configured in an inverted cup shape to facilitate deposition thereon of such material, as well as to promote focusing or intensifying the luminescent flux about the end 36 of an optical fiber 38. Such photoluminescent material, designated as Alpha Phosphor Dots, or AccuDot-6.4, is commercially available, for example, from Luxtron Corp. of Santa Clara, Calif.

In accordance with the illustrated embodiment of the present invention, the optical fiber 38 is embedded and sealed within the base 21 with the end 36 of the fiber disposed away from, and in axial alignment with, the underside of the sensing element 23. In this way, light flux can be supplied to and received from the sensing element 23 along the optical channel of the fiber 38. Thus, a stimulating light pulse may be supplied by optical analyser 39 along the optical channel including fiber 38 and optical fiber cable 41, and resultant fluorescent light flux may be transmitted from the underside of sensing element 23 along the optical channel back to the optical analyzer 39. An optical coupling is formed at the interface of an opposite end 43 of the fiber 38 with the mating end 45 of the optical fiber cable 41 to facilitate convenient detachment of the cable 41 and analyzer 39 from the base 21 of the wafer chuck. A ferrule 47 surrounding the mating end 45 of the optical cable is threaded 49 for mating threaded attachment within recess 51 in the base 21.

In operation, a semiconductor wafer of silicon or gallium arsenide, or the like, is positioned on the upper surface 15 of the wafer chuck over one or more sensor elements 23 that contact the underside of the wafer (not shown). As the wafer is pulled down into engagement with the surface 15 of the chuck by electrostatic force (or alternatively by a vacuum-based chuck where feasible within an operating environment), the disc spring 26 supporting the sensing element 23 deflects and resiliently urges the sensing element 23 into good thermal contact with the underside of the wafer. The fluorescent material of the type previously described that is disposed on the underside of the sensing element 23 is illuminated by a light pulse supplied thereto along the optical channel 38, 41 from the optical analyzer 39. Such fluorescent material, at substantially the same temperature as the sensing element 23 which is at substantially the wafer temperature, exhibits a characteristic luminous output with an intensity that decays with time at a rate determined in known manner by the temperature. Thus, periodic excitation of the fluorescent material with light pulses or other radiant energy from the analyzer 39 produces luminescent responses that can be detected via the optical channel 38, 41 and analyzed in known manner to yield accurate indication of temperature of a wafer in contact with the sensing element 23. In a preferred embodiment of the invention, the wafer chuck 7 operates on electrostatic attraction in accordance with Coulomb's law in known manner, and promotes convenient repeatable operation even within a vacuum environment and in applications requiring gas under pressure supplied to the underside of the wafer (e.g., for cooling). The disc spring 26 thus produces low resilient force, upon initial displacements to facilitate pulling the wafer down against the protruding sensing element 23 and into contact with the surface 15 of the chuck, and produces non-linearly increased resilient force to assure good thermal contact of the sensing element 23 against the wafer while firmly secured against the upper surface 15 of the chuck.

Therefore, sensing wafer temperature within a controlled environment in accordance with the present invention relies upon components of low thermal mass and low thermal resistance to assure prompt and accurate temperature measurement of a wafer of semiconductor or other material. In addition, sensing wafer temperature in accordance with the present invention assures low latency of measurement response without significantly adversely affecting the temperature of a wafer being measured. Sensing temperature in accordance with the present invention is immune from the effects of high frequency energy and luminous plasmas commonly present in semiconductor processing chambers, and produces prompt and repeatably accurate indications of the wafer temperature within the processing environment.

I claim:

1. Apparatus for sensing temperature of an object in contact with a reference surface, the apparatus comprising:
a sensing element resiliently mounted within a recess in the reference surface to contact an object disposed on the reference surface;
photoluminescent material disposed on the sensing element to emit luminous flux in response to energetic excitation thereof; and
an optical channel having one end positioned relative to the sensing element to transfer luminous flux therebetween, and having an opposite end disposed to optically couple to optical analysis apparatus for sensing luminous flux supplied thereto from the optical channel.

2. Apparatus as in claim 1 including a substantially planar spring disposed within the recess of substantially cylindrical configuration to resiliently support the sensing element in substantially coaxial orientation within the recess.

3. Apparatus as in claim 2 in which the spring is configured as a disc disposed within the recess substantially co-planarly with the reference surface for resiliently supporting the sensing element to produce resilient force thereon in a direction toward the reference surface which increases non-linearly with deflection away from the reference surface.

4. Apparatus as in claim 2 including photoluminescent material disposed on the sensing element for emitting radiant flux with an intensity characteristic that is indicative of temperature in response to stimulation thereof with radiant energy; and including
an optical channel having a proximal end disposed near the sensing element for transferring radiant flux between the proximal end and a remote end of the optical channel.

5. Apparatus as in claim 4 in which the optical channel includes a first portion adjacent the proximal end, and a second portion adjacent the remote end; and including
a coupling structure disposed intermediate the proximal and remote ends for selectively optically coupling together the first and second portions of the optical channel.

6. Apparatus as in claim 4 including analyzer apparatus optically coupled to the remote end of the optical channel for selectively supplying successive pulses of radiant energy thereto and for receiving via the optical channel during intervals between pulses the radiant flux emitted by the photoluminescent material in response to pulses of radiant energy supplied thereto.

7. Apparatus as in claim 6 in which the analyzer apparatus responds to the characteristic of rate of change of intensity of radiant flux emitted by the photoluminescent material on the sensing element to determine the temperature thereof.
